(19) United States
(12) Patent Application Publication
(10) Pub. No.: US 2015/0352659 A1
(43) Pub. Date: Dec. 10, 2015

(54) COVER PLATE WITH INTRUDING FEATURE TO IMPROVE AL-STEEL SPOT WELDING

(71) Applicant: GM GLOBAL TECHNOLOGY OPERATIONS LLC, Detroit, MI (US)

(72) Inventors: David R. Sigler, Shelby Township, MI (US); Blair E. Carlson, Ann Arbor, MI (US); David Yang, Shanghai (CN); Hui-Ping Wang, Troy, MI (US)

(21) Appl. No.: 14/724,070

(22) Filed: May 28, 2015

Related U.S. Application Data
(60) Provisional application No. 62/010,204, filed on Jun. 10, 2014.

(51) Int. Cl. B23K 11/36; B23K 11/20; B23K 11/11

(52) U.S. Cl. CPC B23K 11/36; B23K 11/115; B23K 11/20

(57) ABSTRACT

A method of spot welding a workpiece stack-up that includes a steel workpiece and an adjacent aluminum alloy workpiece involves passing an electrical current through the workpieces and between opposed welding electrodes. The formation of a weld joint between the adjacent steel and aluminum alloy workpieces is aided by a cover plate that is located between the aluminum alloy workpiece that lies adjacent to the steel workpiece and the welding electrode disposed on the same side of the workpiece stack-up. The cover plate, which includes an intruding feature, affects the flow pattern and density of the electrical current that passes through the adjacent steel and aluminum alloy workpieces in a way that helps improve the strength of the weld joint.

### CROSS-REFERENCE TO RELATED APPLICATION

This application claims the benefit of U.S. Provisional Application No. 62/010,204, filed on Jun. 10, 2014, the entire contents of which are hereby incorporated by reference.

### TECHNICAL FIELD

The technical field of this disclosure relates generally to resistance spot welding and, more particularly, to resistance spot welding a steel workpiece and an aluminum alloy workpiece.

### BACKGROUND

Resistance spot welding is a process used by a number of industries to join together two or more metal workpieces. The automotive industry, for example, often uses resistance spot welding to join together pre-fabricated metal workpieces during the manufacture of a vehicle door, hood, trunk lid, or lift gate, among others. A number of spot welds are typically formed along a peripheral edge of the metal workpieces or some other bonding region to ensure the part is structurally sound. While spot welding has typically been practiced to join together certain similarly-composed metal workpieces—such as steel-to-steel and aluminum alloy-to-aluminum alloy—the desire to incorporate lighter weight materials into a vehicle body structure has generated interest in joining steel workpieces to aluminum alloy workpieces by resistance spot welding. In particular, the ability to resistance spot weld workpiece stack-ups containing different workpiece combinations (e.g., steel/steel, aluminum alloy/steel, and aluminum alloy/aluminum alloy) would promote production flexibility and reduce manufacturing costs since many vehicle assembly plants already have spot welding infrastructures in place. The aforementioned desire to resistance spot weld dissimilar metal workpieces is not unique to the automotive industry; indeed, it extends other industries that may utilize spot welding as a joining process including the aviation, maritime, railway, and building construction industries, among others.

Resistance spot welding, in general, relies on the resistance to the flow of an electrical current through overlapping metal workpieces and across their faying interface(s) to generate heat. To carry out such a welding process, a set of two opposed spot welding electrodes is clamped at aligned spots on opposite sides of the workpiece stack-up, which typically includes two or three metal workpieces arranged in lapped configuration, at a predetermined weld site. An electrical current is then passed through the metal workpieces from one welding electrode to the other. Resistance to the flow of this electrical current generates heat within the metal workpieces and at their faying interface(s). When the workpiece stack-up includes a steel workpiece and an adjacent aluminum alloy workpiece, the heat generated at the faying interface and within the bulk material of those dissimilar metal workpieces initiates and grows a molten aluminum alloy weld pool that extends into the aluminum alloy workpiece from the faying interface. This molten aluminum alloy weld pool wets the adjacent faying surface of the steel workpiece and, upon cessation of the current flow, solidifies into a weld nugget that forms all or part of a weld joint that bonds the two workpieces together.

In practice, however, spot welding a steel workpiece to an aluminum alloy workpiece is challenging since a number of characteristics of those two metals can adversely affect the strength—most notably the peel strength—of the weld joint. For one, the aluminum alloy workpiece usually contains one or more mechanically tough, electrically insulating, and self-healing refractory oxide layers on its surface. The oxide layer(s) are typically comprised of aluminum oxides, but may include other metal oxide compounds as well, including magnesium oxides when the aluminum alloy workpiece is composed of a magnesium-containing aluminum alloy. As a result of their physical properties, the refractory oxide layer(s) have a tendency to remain intact at the faying interface where they can hinder the ability of the molten aluminum alloy weld pool to wet the steel workpiece and also provide a source of near-interface defects within the growing weld pool. The insulating nature of the surface oxide layer(s) also raises the electrical contact resistance of the aluminum alloy workpiece—namely, at its faying surface and at its electrode contact point—making it difficult to effectively control and concentrate heat within the aluminum alloy workpiece. Efforts have been made in the past to remove the oxide layer(s) from the aluminum alloy workpiece prior to spot welding. Such removal practices can be impractical, though, since the oxide layer(s) have the ability to regenerate in the presence of oxygen, especially with the application of heat from spot welding operations.

The steel workpiece and the aluminum alloy workpiece also possess different properties that tend to complicate the spot welding process. Specifically, steel has a relatively high melting point (˜1500° C.) and relatively high electrical and thermal resistivities, while the aluminum alloy material has a relatively low melting point (˜600° C.) and relatively low electrical and thermal resistivities. As a result of these physical differences, most of the heat is generated in the steel workpiece during current flow. This heat imbalance sets up a temperature gradient between the steel workpiece (higher temperature) and the aluminum alloy workpiece (lower temperature) that initiates rapid melting of the aluminum alloy workpiece. The combination of the temperature gradient created during current flow and the high thermal conductivity of the aluminum alloy workpiece means that, immediately after the electrical current ceases, a situation occurs where heat is not disseminated symmetrically from the weld site. Instead, heat is conducted from the hotter steel workpiece through the aluminum alloy workpiece towards the welding electrode on the other side of the aluminum alloy workpiece, which creates a steep thermal gradient between the steel workpiece and that particular welding electrode.

The development of a steep thermal gradient between the steel workpiece and the welding electrode on the other side of the aluminum alloy workpiece is believed to weaken the integrity of the resultant weld joint in two primary ways. First, because the steel workpiece retains heat for a longer duration than the aluminum alloy workpiece after the electrical current has ceased, the molten aluminum alloy weld pool solidifies directionally, starting from the region nearest the colder welding electrode (often water cooled) associated with the aluminum alloy workpiece and propagating towards the faying interface. A solidification front of this kind tends to sweep or drive defects—such as gas porosity, shrinkage voids, micro-cracking, and surface oxide residue—towards and along the faying interface within the weld nugget. Second, the sustained elevated temperature in the steel workpiece promotes the growth of brittle Fe—Al intermetallic compounds at and along the faying interface. The intermetallic compounds tend to form thin reaction layers between the weld nugget and the steel workpiece. These intermetallic layers, if present, are generally considered part of the weld joint in addition to the weld nugget. Having a dispersion of weld nugget defects together with excessive growth of Fe—Al intermetallic compounds along the faying interface tends to reduce the peel strength of the final weld joint.

In light of the aforementioned challenges, previous efforts to spot weld a steel workpiece and an aluminum-based workpiece have employed a weld schedule that specifies higher currents, longer weld times, or both (as compared to spot welding steel-to-steel), in order to try and obtain a reasonable weld bond area. Such efforts have been largely unsuccessful in a manufacturing setting and have a tendency to damage the welding electrodes. Given that previous spot welding efforts have not been particularly successful, mechanical fasteners such as self-piercing rivets and flow-drill screws have predominantly been used instead. Such mechanical fasteners, however, take much longer to put in place and have high consumable costs compared to spot welding. They also add weight to the vehicle body structure—weight that is avoided when joining is accomplished by way of spot welding—that offsets some of the weight savings attained through the use of aluminum alloy workpieces in the first place. Advancements in spot welding that would make the process more capable of joining steel and aluminum alloy workpieces would thus be a welcome addition to the art.

### SUMMARY OF THE DISCLOSURE

A method of resistance spot welding a workpiece stack-up that includes at least a steel workpiece and an overlapping adjacent aluminum alloy workpiece is disclosed. The workpiece stack-up may also include an additional workpiece such as another steel workpiece or another aluminum alloy workpiece so long as an aluminum alloy workpiece provides one side of the workpiece stack-up and a steel workpiece provides the other side of the stack-up. As such, the workpiece stack-up may include only a steel workpiece and an overlapping aluminum alloy workpiece, or it may include two neighboring steel workpieces disposed adjacent to an aluminum alloy workpiece or two neighboring aluminum alloy workpieces disposed adjacent to a steel workpiece. Additionally, when the workpiece stack-up includes three workpieces, the two workpieces of similar composition may be provided by separate and distinct parts or, alternatively, they may be provided by the same part.

The disclosed method includes locating a cover plate, which includes an intruding feature, adjacent to an aluminum alloy workpiece on one side of the workpiece stack-up at a weld site. The cover plate can be constructed to have higher thermal and electrical resistivities than the aluminum alloy workpiece it is located next to, but does not necessarily have to be. A welding electrode is then brought into contact with, and pressed against, the cover plate over the intruding feature while another welding electrode is brought into contact with, and pressed against, an opposite side of the workpiece stack-up. An electrical current of sufficient magnitude and duration (constant or pulsed) is passed between the welding electrodes through the workpieces and the cover plate. Passage of the electrical current initiates and grows a molten aluminum alloy weld pool within the aluminum alloy workpiece that lies adjacent to the steel workpiece. This molten aluminum alloy weld pool wets an adjacent faying surface of the steel workpiece and extends into, and possibly through, the aluminum alloy workpiece from the faying interface of the adjacent workpieces. Eventually, after the electrical current has ceased, the molten aluminum alloy weld pool cools and solidifies into a weld joint that bonds the adjacent steel and aluminum alloy workpieces together.

The spot welding method is assisted by the intruding feature defined in the cover plate. In particular, during spot welding, the intruding feature causes the electrical current being exchanged between the welding electrodes to assume a conical flow pattern within the aluminum alloy workpiece situated adjacent to the steel workpieces at the onset of current flow and, in some instances, for the entire duration of current flow. The conical flow pattern results in a decrease in the current density within the aluminum alloy workpiece—as compared to the adjacent steel workpiece—which forms three-dimensional temperature gradients around the molten aluminum alloy weld pool to help the weld pool solidify into the weld joint in a more desirable way. This more-desirable solidification behavior is further promoted when the cover plate is constructed of a more thermally and electrically resistive material than the aluminum alloy workpiece situated adjacent to the steel workpiece since, in that scenario, the cover plate creates additional heat and also retains heat for a longer duration than the aluminum alloy workpiece after cessation of the current flow. Furthermore, if the cover plate is placed in direct contact with the aluminum alloy workpiece that lies adjacent to the steel workpiece and the intruding feature is open at the neighboring aluminum alloy workpiece, the intruding feature provides an open space or volume that allows for movement of the molten aluminum alloy weld pool during current flow, which helps break up and redistribute defects caused by oxide residue near the faying interface, thus improving the mechanical properties of the weld joint.

Numerous welding electrode designs can be used in conjunction with the cover plate. This facilitates process flexibility. Specifically, there is no need to use welding electrodes that meet stringent size and shape requirements in order to successfully spot weld workpiece stack-ups that include adjacent steel and aluminum alloy workpieces. Each of the welding electrodes can, therefore, be constructed with other purposes in mind, such as spot welding steel-to-steel or aluminum alloy-to-aluminum alloy. As such, the same welding electrodes that are typically used to spot weld an aluminum alloy workpiece to an aluminum alloy workpiece may also be used to spot weld a steel workpiece to an aluminum alloy workpiece with the assistance of the cover plate, meaning that the same welding gun setup can be used to spot weld both sets of workpiece stack-ups without having to substitute either or both of the welding electrodes. The same is also true for welding electrodes that are typically used to spot weld steel-to-steel. In fact, some welding electrodes can even be used to spot-weld all three sets of stack-ups—i.e., steel-to-steel, aluminum alloy-to-aluminum alloy, and steel-to-aluminum alloy (with the assistance of the cover plate).

### BRIEF DESCRIPTION OF THE DRAWINGS

FIG. 1 is a side elevational view of a workpiece stack-up that, according to one embodiment, includes a steel workpiece and an aluminum alloy workpiece assembled in overlapping fashion for resistance spot welding, and wherein cover plate is located adjacent to the aluminum alloy workpiece such that the stack-up and cover plate are situated between a pair of opposed welding electrodes;

FIG. 2 is a partial magnified cross-sectional view of the stack-up, cover plate, and opposed welding electrodes depicted in FIG. 1;

FIG. 3 is a partial exploded cross-sectional side view of the stack-up, cover plate, and opposed welding electrodes depicted in FIG. 2;

FIG. 4 is a cross-sectional view of an intruding feature included in the cover plate according to one embodiment;

FIG. 5 is a cross-sectional view of an intruding feature included in the cover plate according to another embodiment;

FIG. 6 is a cross-sectional view of an intruding feature included in the cover plate according to yet another embodiment;

FIG. 7 is a partial cross-sectional view of a workpiece stack-up, which according to one embodiment includes a steel workpiece and an aluminum alloy workpiece, and a cover plate located adjacent to the aluminum alloy workpiece before passage of an electrical current between opposed welding electrodes, wherein a first welding electrode is contacting an exterior surface of the steel workpiece and a second welding electrode is contacting the cover plate;

FIG. 8 is a partial cross-sectional view of the stack-up and a cover plate, as depicted in FIG. 7, during spot welding in which a molten aluminum alloy weld pool has been initiated within the aluminum alloy workpiece and at the faying interface of the steel and aluminum alloy workpieces;

FIG. 9 is a partial cross-sectional view of the stack-up of FIG. 8 after stoppage of the electrical current, retraction of the welding electrodes, and removal of the cover plate, wherein a weld joint has been formed at the faying interface of the steel and aluminum alloy workpieces;

FIG. 10 is an idealized illustration showing the direction of the solidification front in a molten aluminum alloy weld pool that solidifies from the point nearest the colder welding electrode located against the aluminum alloy workpiece towards the faying interface when a cover plate according to the present disclosure is not being used;

FIG. 11 is an idealized illustration showing the direction of the solidification front in a molten aluminum alloy weld pool when, on account of a cover plate that includes an intruding feature, the molten aluminum alloy weld pool solidifies from its outer perimeter towards it center;

FIG. 12 is a partial cross-sectional view of the stack-up and a cover plate during spot welding in which a molten aluminum alloy weld pool has been initiated within the aluminum alloy workpiece and at the faying interface and, additionally, a molten steel weld pool has been initiated within the steel workpiece;

FIG. 13 is a partial cross-sectional view of the stack-up of FIG. 12 after stoppage of the electrical current, retraction of the welding electrodes, and removal of the cover plate, wherein a weld joint has been formed at the faying interface and a steel weld nugget has been formed within the steel workpiece;

FIG. 14 is a side elevational view of a workpiece stack-up that, according to another embodiment, includes a steel workpiece, an adjacent aluminum alloy workpiece, and an additional steel workpiece assembled in overlapping fashion for resistance spot welding, and wherein a cover plate is located adjacent to the aluminum alloy workpiece such that the stack-up and cover plate are situated between a pair of opposed welding electrodes; and

FIG. 15 is a side elevational view of a workpiece stack-up that, according to yet another embodiment, includes a steel workpiece, an adjacent aluminum alloy workpiece, and an additional aluminum alloy workpiece assembled in overlapping fashion for resistance spot welding, and wherein a cover plate is located adjacent to the additional aluminum alloy workpiece such that the stack-up and cover plate are situated between a pair of opposed welding electrodes.

### DETAILED DESCRIPTION

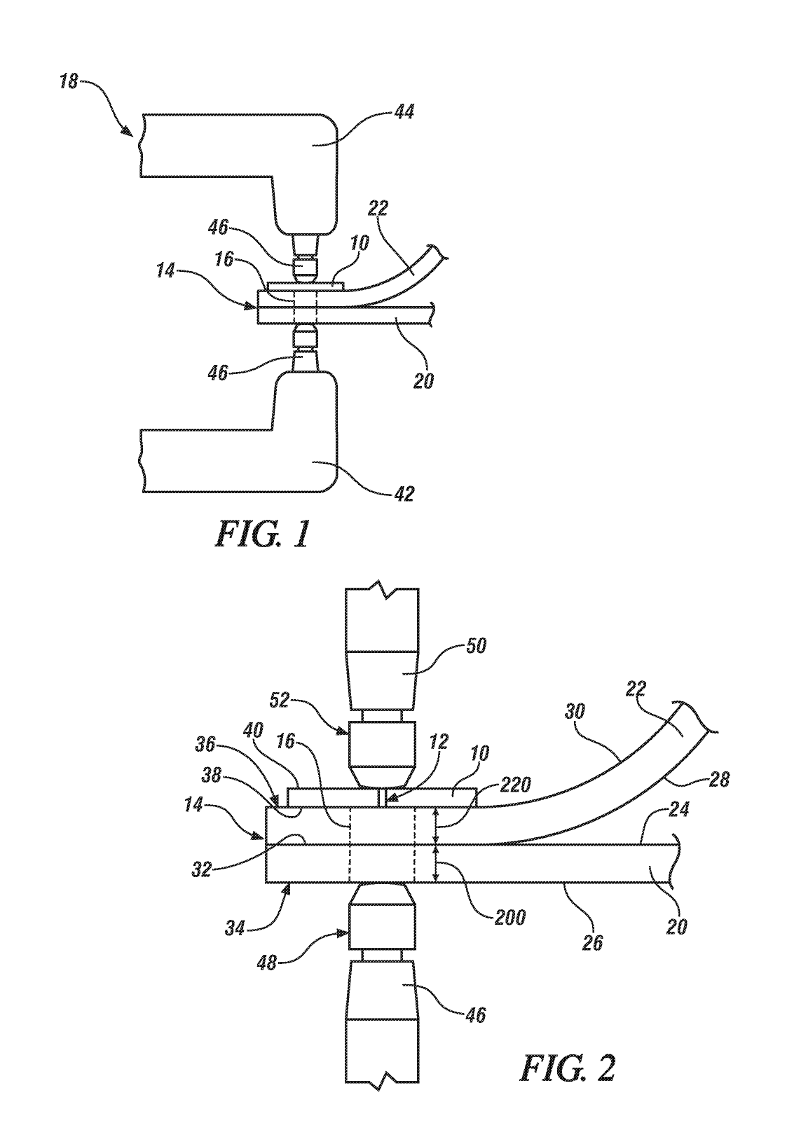

Preferred and exemplary embodiments of a method of spot welding a workpiece stack-up that includes a steel workpiece and an adjacent aluminum alloy workpiece are shown in FIGS. 1-15 and described below. The described embodiments use a cover plate 10 that includes an intruding feature 12. The cover plate 10 is located adjacent to an aluminum alloy workpiece on one side of the workpiece stack-up between a welding electrode and the workpiece stack-up so as to affect the flow pattern and density of the electrical current that passes through the several overlapping workpieces. Additionally, in some instances, the cover plate 10 provides a medium on the side of the workpiece-stack up between and the aluminum alloy workpiece that lies adjacent to the steel workpiece and the welding electrode that confronts that particular side of the stack-up. In this way, the cover plate 10 can generate heat during current flow and retain heat for a longer duration than the aluminum alloy workpiece situated adjacent to the steel workpiece at the weld site. Still further, if the cover plate is placed in direct contact with the aluminum alloy workpiece that lies adjacent to the steel workpiece and the intruding feature is open at the neighboring aluminum alloy workpiece, the intruding feature allows for movement of the molten aluminum alloy weld pool during current flow, which helps break up and redistribute defects caused by oxide residue near the faying interface. These functional effects of the cover plate 10 help form a strong weld joint between the adjacent steel and aluminum alloy workpieces by modifying the solidification behavior of the molten aluminum alloy weld pool formed within the aluminum alloy workpiece.

FIGS. 1-3 generally depict the cover plate 10 and a workpiece stack-up 14 that are stacked in overlapping fashion for resistance spot welding at a predetermined weld site 16 by a welding gun 18. The workpiece stack-up 14 includes a steel workpiece 20 and an aluminum alloy workpiece 22. The steel workpiece 20 is preferably a galvanized (zinc-coated) low carbon steel. Other types of steel workpieces may of course be used including a low carbon bare steel or a galvanized advanced high strength steel (AHSS). Some specific types of steels that may be used in the steel workpiece 20 are interstitial-free (IF) steel, dual-phase (DP) steel, transformation-induced plasticity (TRIP) steel, and press-hardened steel (PHS). Regarding the aluminum alloy workpiece 22, it may be an aluminum-magnesium alloy, an aluminum-silicon alloy, an aluminum-magnesium-silicon alloy, or an aluminum-zinc alloy, and it may be coated with its natural refractory oxide coating or, alternatively, it may be coated with zinc, tin, or a conversion coating to improve adhesive bond performance. Some specific aluminum alloys that may be used in the aluminum alloy workpiece 22 are AA5754 aluminum-magnesium alloy, AA6111 and AA6022 aluminum-magnesium-silicon alloy, and AA7003 aluminum-zinc alloy. The term “workpiece” and its steel and aluminum variations is used broadly in the present disclosure to refer to a wrought sheet metal layer, a casting, an extrusion, or any other resistance spot weldable substrate, inclusive of any surface layers or coatings, if present.

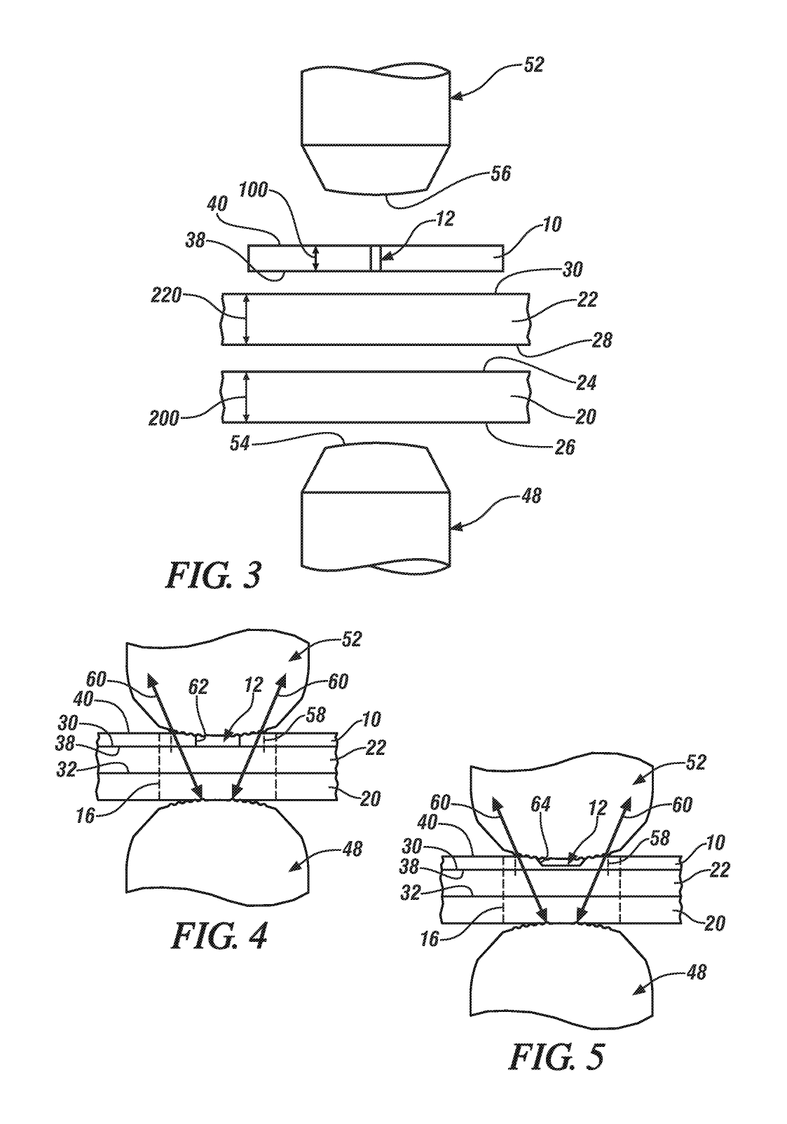

When stacked-up for spot welding, as shown best in FIGS. 2-3, the steel workpiece 20 includes a faying surface 24 and an exterior surface 26. Likewise, the aluminum alloy workpiece 22 includes a faying surface 28 and an exterior surface 30. The faying surfaces 24, 28 of the two workpieces 20, 22 overlap one another to provide a faying interface 32 at the weld site 16. The faying interface 32, as used herein, encompasses instances of direct contact between the faying surfaces 24, 28 of the workpieces 20, 22 as well as instances of indirect contact such as when the faying surfaces 24, 28 are not touching but are in close enough proximity to each another—e.g., when a thin layer of adhesive, sealer, or some other intermediate material is present—that resistance spot welding can still be practiced. A thin coating of a sealer or adhesive may be applied between the faying surfaces 24, 28 of the workpieces 20, 22 in some instances to help hold the workpieces 20, 22 together along their faying interface 32.

The exterior surfaces 26, 30 of the steel and aluminum alloy workpieces 20, 22, on the other hand, generally face away from each other in opposite directions to make them accessible by a pair of opposed spot welding electrodes. Here, in this embodiment, the exterior surface 26 of the steel workpiece 20 provides and delineates a first side 34 of the workpiece stack-up 14 and the exterior surface 30 of the aluminum alloy workpiece provides and delineates an opposed second side 36 of the stack-up 12. Each of the steel and aluminum alloy workpieces 20, 22 preferably has a thickness 200, 220—which is measured from the faying surface 24, 28 to the exterior surface 26, 30 of each workpiece 20, 22—that ranges from 0.3 mm to 6.0 mm, and more preferably from 0.5 mm to 4.0 mm, at least at the weld site 16.

The cover plate 10, as shown, is located adjacent to the second side 36 of the workpiece stack-up 14 next to the aluminum alloy workpiece 22 such that the intruding feature 12 is present at the weld site 16. The cover plate 10 includes an interior surface 38, which confronts and preferably makes interfacial contact with the exterior surface 30 of the aluminum alloy workpiece 22 when located, and an oppositely-facing exterior surface 40. The cover plate 10 has a thickness 100 between its surfaces 38, 40 at the weld site 16 that may range from 0.2 mm to 10 mm. In terms of its composition, the cover plate 10 may be composed of a material that has higher thermal and electrical resistivities than the aluminum alloy workpiece 22 or a material that has lower thermal and electrical resistivities than the aluminum alloy workpiece 22. The material of the cover plate 10 is also preferably non-reactive or nearly non-reactive with the aluminum alloy workpiece 22 during spot welding in order to avoid contaminating the workpiece 22 with metal reaction products.

For example, the cover plate 10 made be made out of a material that has a thermal resistivity and an electrical resistivity that are not only higher than the aluminum alloy workpiece 22, but are also at least twice as great as the thermal resistivity of commercially pure annealed copper and the electrical resistivity of commercially pure annealed copper as defined by the International Annealed Copper Standard (i.e., 100% IACS), respectively. The electrical resistivity of commercially pure annealed copper as defined by the IACS is 1.72×10⁻⁸ Ω/m. And the thermal resistivity for commercially pure annealed copper is defined herein as 2.6×10⁻³ (m° K)/W. Some specific materials of this kind include molybdenum, stainless steel, or a tungsten-copper alloy such as an alloy having 55 wt. % to 85 wt. % tugsten and 45 wt. % to 15 wt. % copper. Alternatively, as another example, the cover plate 10 may be made out of a copper alloy that has a lower thermal resistivity and electrical resistivity than the aluminum alloy workpiece 22. One specific example of a suitable copper alloy is a zirconium copper alloy (ZrCu) that contains 0.10 wt. % to 0.20 wt. % zirconium and the balance copper, although other copper alloy compositions may of course be used.

The welding gun 18 used to spot weld the workpiece stack-up 14 and to join together the steel and aluminum alloy workpieces 20, 22 at their faying interface 32 may be any known type. For example, as shown here in FIGS. 1-2, the welding gun 18, which is part of a larger automated welding operation, includes a first gun arm 42 and a second gun arm 44 that are mechanically and electrically configured to repeatedly form spot welds in accordance with a defined weld schedule. The first gun arm 42 has a first electrode holder 46 that retains a first welding electrode 48, and the second gun arm 40 has a second electrode holder 50 that retains a second welding electrode 52. The first and second welding electrodes 48, 52 are each preferably formed from an electrically conductive material such as copper alloy. One specific example is a zirconium copper alloy (ZrCu) that contains 0.10 wt. % to 0.20 wt. % zirconium and the balance copper. Copper alloys that meet this constituent composition and are designated C15000 are preferred. Of course, other copper alloy compositions that possess suitable mechanical and electrically conductive properties may also be employed. The weld gun 18 depicted generally in FIGS. 1-2 is meant to be representative of a wide variety of weld guns, including c-type and x-type weld guns, as well as other weld gun types not specifically mentioned so long as they are capable of spot welding the workpiece stack-up 14.

The first welding electrode 48 includes a first weld face 54 and the second welding electrode 52 includes a second weld face 56. The weld faces 54, 56 of the first and second welding electrodes 48, 52 are the portions of the electrodes 48, 52 that, during spot welding, are pressed against the first side 34 of the workpiece stack-up 14, which in this embodiment is also the exterior surface 26 of the steel workpiece 20, and the exterior surface 40 of the cover plate 10 that overlies the second side 36 of the workpiece stack-up 14, respectively. Each of the weld faces 54, 56 may be flat or domed, and may further include surface features (e.g., surface roughness, ringed features, a plateau, etc.) as described, for example, in U.S. Pat. Nos. 6,861,609, 8,222,560, 8,274,010, 8,436,269, 8,525,066, and 8,927,894. A mechanism for cooling the electrodes 48, 52 with water is typically incorporated into the gun arms 42, 44 and the electrode holders 46, 50 to manage the temperatures of the welding electrodes 48, 52.

The welding gun arms 42, 44 are operable during spot welding to press the weld faces 54, 56 of the first and second welding electrodes 48, 52 against the exterior surface 26 of the steel workpiece 20 and the exterior surface 40 of the cover plate 10, respectively. The first and second weld faces 54, 56 are typically pressed against their respective exterior surfaces 26, 40 in facing axial alignment with one another at the intended weld site 16. An electrical current is then delivered from a controllable power source (not shown) in electrical communication with the welding gun 18. The applied electrical current is passed between the welding electrodes 48, 52. The magnitude and duration of the electrical current are set by a weld schedule programmed specifically to effectuate joining together the steel and aluminum alloy workpieces 20, 22.

Referring now to FIG. 4, the intruding feature 12 defined within the cover plate 10 may extend partially or fully between the interior and exterior surfaces 38, 40 of the cover plate 10 to provide a void within the plate 10. When pressed against the exterior surface 40 of the cover plate 10 at the start of current flow, the weld face 56 of the second welding electrode 52 makes contact with the exterior surface 40 over the intruding feature 12. In other words, if the peripheral boundary of the surface area of the exterior surface 40 contacted by the weld face 56 at the start of current flow is extrapolated to the exterior surface 30 of the aluminum alloy workpiece 22, as illustrated here by reference numeral 58, the intruding feature 12 would be completely contained within that delineated region. This relationship between the contacted area of the exterior surface 40 of the cover plate 10 and the intruding feature 12 applies whether the aluminum alloy workpiece 22 is the top or bottom workpiece in the stack-up 14. Accordingly, the term “over” should not be read to always require the aluminum alloy workpiece 22 to be on top of the steel workpiece 20 so that, strictly speaking, the second welding electrode 48 is above the intruding feature 12.

The intruding feature 12 causes the electrical current being exchanged between the welding electrodes 48, 52 to assume a conical flow pattern within the aluminum alloy workpiece 22 at least at the onset of current flow, as represented by arrows 60. The conical electrical current flow pattern 60 induced by the intruding feature 12 expands radially from the faying interface 32 towards the second welding electrode 52. By inducing the conical flow pattern 60, and thus decreasing the current density in the aluminum alloy workpiece 22 directionally from the faying interface 32 towards the second welding electrode 52, heat is concentrated within a smaller zone in the steel workpiece 20 as compared to the aluminum alloy workpiece 22. This function of the cover plate 10 creates three-dimensional temperature gradients—in particular radial temperature gradients acting in the plane of the workpieces 20, 22—that change the solidification behavior of the molten aluminum alloy weld pool initiated and grown at the faying interface 32 so that defects in the ultimately-formed weld joint are directed to a more innocuous location. And when the cover plate 10 is constructed from a material that has higher thermal and electrical resistivities than the aluminum alloy workpiece 22, such as molybdenum, it also provides a medium between the aluminum alloy workpiece 22 and the second welding electrode 52 that generates heat during current flow and, additionally, retains heat for a longer duration than the aluminum alloy workpiece 22 after passage of the electrical current between the electrodes 48, 52 has ceased. Such additional heating further promotes the solidification behavior induced by the conical electrical current flow pattern 60.

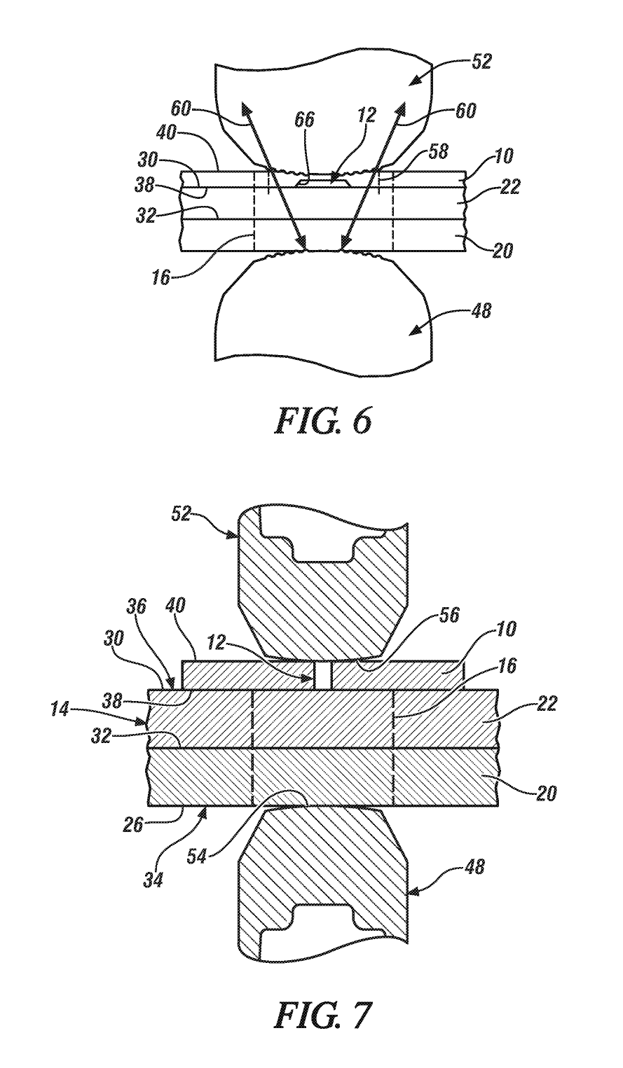

The intruding feature 12 may be constructed in numerous ways. In one specific embodiment, as shown in FIG. 4, the intruding feature 12 may be a through hole 62 that extends between the interior and exterior surfaces 38, 40 of the cover plate 10 to entirely traverse the thickness 100 of the cover plate 10. The intruding feature 12, however, does not necessarily have to extend all the way through the cover plate 10 in that way. For example, in another embodiment, as shown in FIG. 5, the intruding feature 12 may be a depression 64 that partially traverses the thickness 100 of the cover plate 10, extending from the exterior surface 40 of the plate 10 but not reaching the interior surface 38. Similarly, in another embodiment, as shown in FIG. 6, the intruding feature 12 may be a depression 66 that partially traverses the thickness 100 of the cover plate 10, this time extending from the interior surface 38 of the plate 10 but not reaching the exterior surface 40.

The intruding features 62, 66 shown in FIGS. 4 and 6 are examples of features that are open to the exterior surface 30 of the aluminum alloy workpiece 22 when the interior surface 38 of the cover plate 10 is placed into direct contact with the exterior surface 30 of the aluminum alloy workpiece 22. Under such circumstances, the intruding features 62, 66 in FIGS. 4 and 6, respectively, as well as other similarly open intruding features, provide an open space or volume that allows for movement of the molten aluminum alloy weld pool, especially when the weld pool penetrates entirely through the aluminum alloy workpieces 22 to its exterior surface 30. This type of movement or stirring of the molten aluminum alloy weld pool can improve the mechanical properties of the weld joint by breaking up and redistributing oxide residue defects that are oftentimes found near the faying interface 32.

FIGS. 1-2 and 7-9 illustrate one embodiment of a spot welding process in which the workpiece stack-up 14 is spot-welded at the weld site 16 to join together the steel and aluminum alloy workpieces 20, 22 at their faying interface 32 with the assistance of the cover plate 10. The cover plate 10, here, has higher thermal and electrical resistivities than the aluminum alloy workpiece 22, and is preferably constructed of molybdenum, stainless steel, or a tungsten-copper alloy. To begin, the workpiece stack-up 14 is located between the first and second welding electrodes 48, 52 so that the weld faces 54, 56 of the electrodes 48, 52 are aligned and face one another at the weld site 16. The workpiece stack-up 14 may be brought to such a location, as is often the case when the gun arms 42, 44 are part of a stationary pedestal welder, or the gun arms 42, 44 may be robotically moved to locate the welding electrodes 48, 52 relative to the weld site 16. While the first and second welding electrodes 48, 52 are still separated, the cover plate 10 is located adjacent to the aluminum alloy workpiece 22 so that the intruding feature 12 is present at the weld site 16 and aligned with the impending trajectory of the second welding electrode 52. Preferably, as shown, the interior surface 38 of the cover plate 10 lies against in direct contact with the exterior surface 30 of the aluminum alloy workpiece 22.

Once the workpiece stack-up 14 and the cover plate 10 are properly located, the first and second gun arms 42, 44 converge relative to one another to bring the first welding electrode 48 into contact with the steel workpiece 20 and the second welding electrode 52 into contact with the cover plate 10, each at the weld site 16, as shown in FIG. 7. In particular, the weld face 54 of the first welding electrode 48 is pressed against the exterior surface 26 of the steel workpiece 20 at the first side 34 of the workpiece stack-up 14, and the weld face 56 of the second welding electrode 52 is pressed against the exterior surface 40 of the cover plate 10 over the intruding feature 12. The weld face 56 of the second welding electrode 52 makes contact with an annular portion of the exterior surface 40 of the cover plate 10 surrounding the intruding feature 12 to facilitate current flow to the welding electrode 52 in the desired conical flow pattern 60. The clamping force assessed by the gun arms 42, 44 helps establish good mechanical and electrical contact between the welding electrodes 48, 52 and the exterior surfaces 26, 40 they engage.

An electrical current—typically a DC current between about 5 kA and about 50 kA—is then passed between the weld faces 54, 56 and through the cover plate 10 and workpiece stack-up 14 at the weld site 16 as prescribed by the weld schedule. The electrical current is typically passed as a constant current or a series of current pulses over a period of about 40 milliseconds to about 1000 milliseconds. At least at the beginning of current flow, the intruding feature 12 in the cover plate 10 causes the current to assume the conical flow pattern 60 within the aluminum alloy workpiece 22. The conical flow pattern 60 develops because the intruding feature 12 serves as an electrically insulative void within the cover plate 10 between the aluminum alloy workpiece 22 and the second welding electrode 52. The presence of such an electrically insulative void forces the electrical current to expand radially from the faying interface 32 towards the weld face 56 of the second welding electrode 52, as previously described. The first welding electrode 48, on the other hand, passes the electrical current through a more concentrated sectional area within the steel workpiece 20.

The passage of the electrical current between the welding electrodes 48, 52 causes the cover plate 10 and the steel workpiece 20 to initially heat up more quickly than the aluminum alloy workpiece 22 as a result of their relatively higher thermal and electrical resistivities. The heat generated from the resistance to the flow of electrical current across the faying interface 32 eventually melts the aluminum alloy workpiece 22 at the weld site 16 and initiates a molten aluminum alloy weld pool 68, as depicted in FIG. 8. The continued passing of the electrical current through the workpieces 20, 22 ultimately grows the molten aluminum alloy weld pool 68 to the desired size which, in many instances, as shown here, results in the weld pool 68 fully penetrating through the entire thickness 220 of the aluminum alloy workpiece 22 such that it contacts the adjacent interior surface 38 of the cover plate 10. The intruding feature 12 may become partially or fully filled with molten aluminum alloy at this time if the feature 12 is accessible at the exterior surface 30 of the aluminum alloy workpiece 22 like, for example, those intruding features 12 depicted in FIGS. 4 and 6. This action allows for movement of the molten aluminum alloy weld pool 68 and thus helps break up and redistribute oxide residue defects located near the faying interface 32. During its initiation and growth phases, the molten aluminum alloy weld pool 68 wets an adjacent area of the faying surface 24 of the steel workpiece 20.

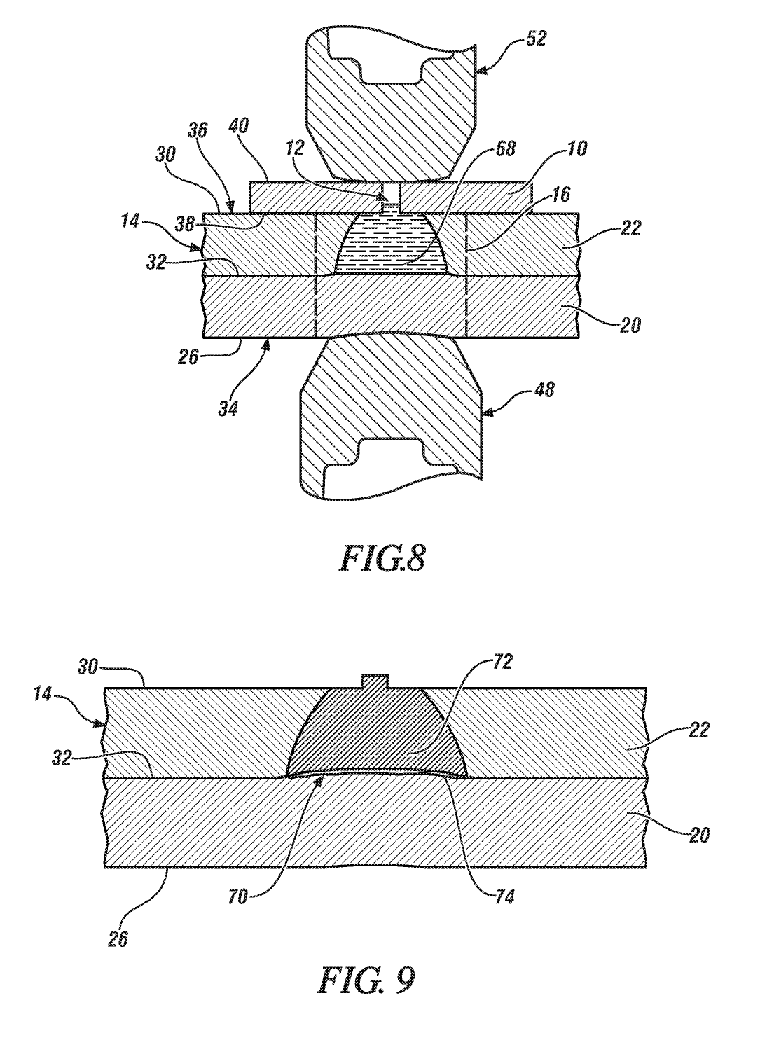

The inducement of the conical electrical current flow pattern 60 within the aluminum alloy workpiece 22 results in heat being concentrated within a smaller zone in the steel workpiece 20 as compared to the aluminum alloy workpiece 22. Because heat is less concentrated in the aluminum alloy workpiece 22, less damage is done to the surrounding portions of the aluminum alloy workpiece 22 outside of the weld site 16. Eventually, when the electrical current flow ceases, the molten aluminum alloy weld pool 68 solidifies to form a weld joint 70 that bonds the steel and aluminum alloy workpieces 20, 22 together at the faying interface 32, as illustrated generally in FIG. 9. The weld joint 70 includes an aluminum alloy weld nugget 72 and, typically, one or more reaction layers 74 of Fe—Al intermetallic compounds. The aluminum alloy weld nugget 72 penetrates into the aluminum alloy workpiece 22 to a distance that exceeds 20% of the thickness 220 of the aluminum alloy workpiece 22, oftentimes fully penetrating through the entire thickness 220 (i.e., 100%) of the workpiece 22.

The one or more reaction layers 74 of Fe—Al intermetallic compounds, if present, are situated between the bulk of the aluminum alloy weld nugget 72 and the steel workpiece 20. These layers are produced mainly as a result of reaction between the molten aluminum alloy weld pool 68 and the steel workpiece 20 at spot welding temperatures during current flow and for a short period of time after current flow when the steel workpiece 20 is still hot. The one or more layers of Fe—Al intermetallic compounds may include intermetallics such as FeAl₃ and Fe₂Al₅, as well as others, and their combined thickness typically ranges from 1 μm to 3 μm, when measured in the same direction as the thicknesses 200, 220 of the workpieces 20, 22, in at least the portion of the weld joint 70 underneath where the intruding feature 12 was present. A total intermetallic reaction layer(s) thickness of 1 μm to 3 μm at this location is thinner than what would be expected if the cover plate 10 is not used.

The use of the cover plate 10 is believed to improve the strength and integrity of the weld joint 70 in at least two ways. First, the added heat from the cover plate 10 reduces the amount of heat required to be input from the steel workpiece 20 in order to create the molten aluminum alloy weld pool 68, which in turn reduces the amount of brittle intermetallic compounds formed at the faying interface 32. Second, the cover plate 10 induces the conical electrical current flow pattern 60 and also facilitates the creation of a region of retained heat on each side of the aluminum alloy workpiece 22 following cessation of the electrical current flow. In particular, as a result of the cover plate 10 inducing the conical electrical current flow pattern 60, heat is concentrated within a smaller zone in the steel workpiece 20 at the weld site 16 as compared to the aluminum alloy workpiece 22. And since the steel workpiece 20 has a higher thermal resistivity than the aluminum alloy workpiece 22, the heat generated within the steel workpiece 20 lingers for a longer time than it would in the aluminum alloy workpiece 22. Similarly, on the other side of the aluminum alloy workpiece 22, the cover plate itself 10 retains heat generated at the weld site 16 since it has a higher thermal resistivity than the aluminum alloy workpiece 22 as well. The heat generated within the cover plate 10 is the result of the electrical current that had recently passed through it. Moreover, if the cover plate 10 is placed in direct contact with the aluminum alloy workpiece 22 and the intruding feature 12 is open at the aluminum alloy workpiece 22, as shown in FIGS. 4 and 6, the intruding feature 12 allows for the movement or stirring of the molten aluminum alloy weld pool during current flow that is believed to be beneficial as previously described.

The inducement of the conical flow pattern 60 and the presence of a retained heat region on each side of the aluminum alloy workpiece 22 cause the molten aluminum alloy weld pool 68 to solidify in a more desired way—that is, from its outer perimeter towards its center. This occurs because heat from the steel workpiece 20 can no longer disseminate down a strong thermal gradient to the colder second welding electrode 52. Instead, here, the conical flow pattern 60 and the retained heat regions change the temperature distribution through the weld site 16 by creating three-dimensional radial temperature gradients within the plane of the steel workpiece 20 that are reflected in the plane of the aluminum alloy workpiece 22. These gradients help disseminate heat laterally through the workpieces 20, 22 such that the solidification front of the molten aluminum alloy weld pool 68 moves inward from the perimeter of the weld pool 68 as opposed to directionally towards the faying interface 32. Such solidification behavior sweeps or drives weld defects away from the nugget perimeter and toward the center of the weld joint 70 where they are less prone to weaken the joint 68 and interfere with its structural integrity.

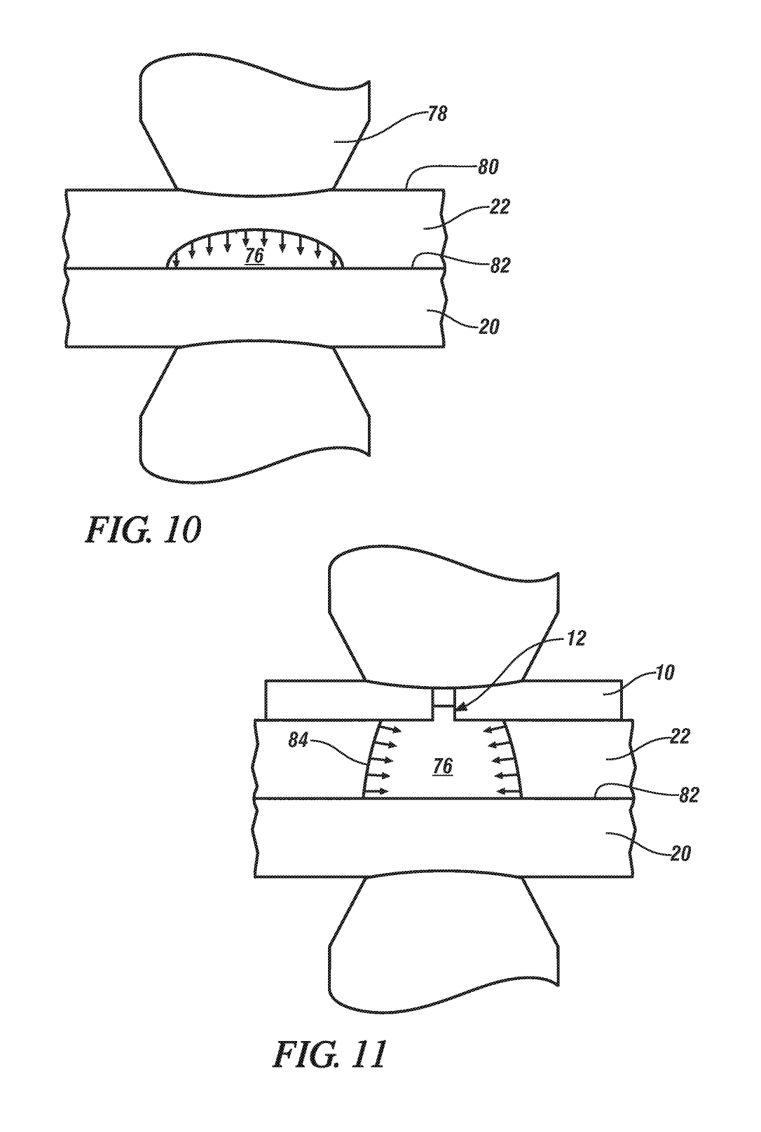

FIGS. 10-11 help visualize the solidification behavior thought to occur when the cover plate 10 is employed. In FIG. 10, where a cover plate that includes an intruding feature is not present, a molten aluminum alloy weld pool 76 solidifies directionally from the point nearest the colder welding electrode 78 located against the exterior surface 80 of the aluminum alloy workpiece 22 towards the faying interface 82, which, consequently, drives weld defects towards and along the faying interface 82. In contrast, in FIG. 11, where a cover plate 10 that has higher thermal and electrical conductivities than the aluminum alloy workpiece 22 is present, the molten aluminum alloy weld pool 76 solidifies from its outer perimeter 84 towards its center, which drives weld defects to conglomerate more in the center of the ultimately-formed weld joint and limits their dispersal at and along the faying interface 82, leading to a stronger weld joint.

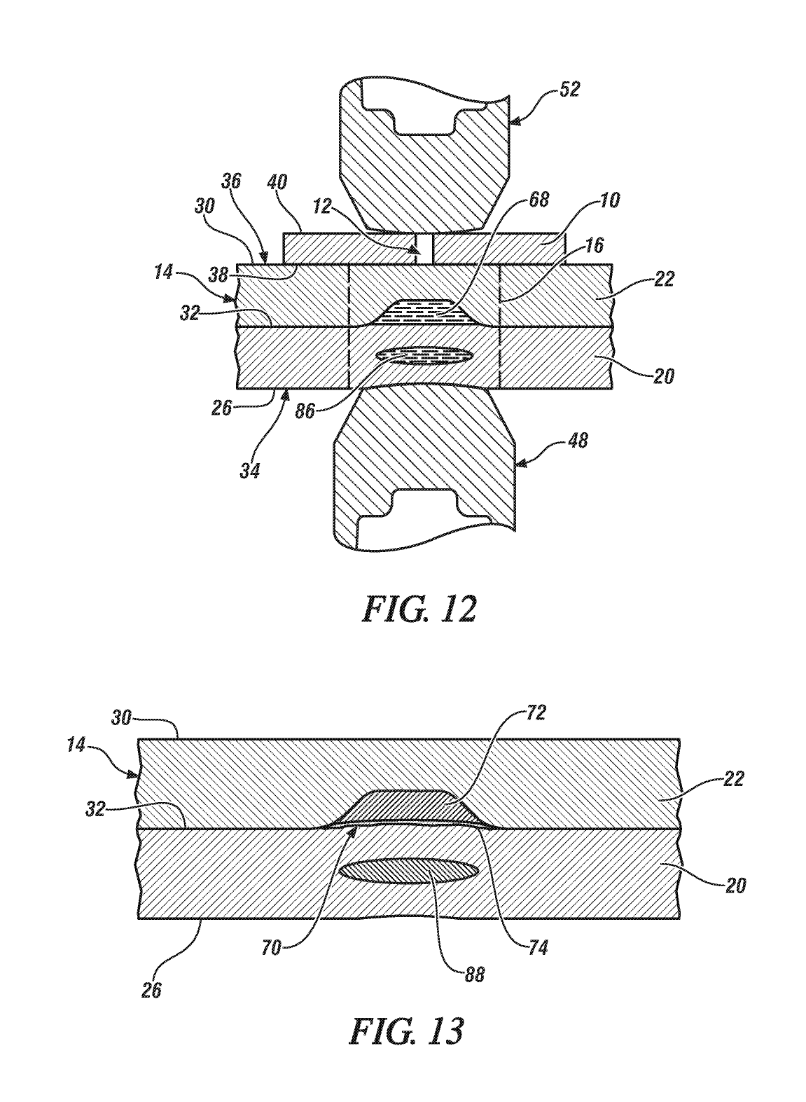

FIGS. 1-2, 7, and 12-13 illustrate another embodiment of a spot welding process in which the stack-up 14 is spot-welded at the weld site 16 with the assistance of the cover plate 10. The cover plate 10, here, has lower thermal and electrical resistivities than the aluminum alloy workpiece 22, and is preferably constructed of a copper alloy such as a zirconium copper alloy (ZrCu). The spot welding process depicted in FIGS. 12-13 is similar in many respects to the spot welding process shown in FIGS. 8-9. As such, much of the above process description will not be repeated, and only the main differences will be discussed in further detail below.

After the first welding electrode 48 is brought into contact with the steel workpiece 20 at the first side 34 of the workpiece stack-up 14 and the second welding electrode 52 is brought into contact with the cover plate 10 over the intruding feature 12, as shown in FIG. 7, an electrical current is passed between the electrode weld faces 54, 56 and through the cover plate 10 and workpiece stack-up 14 at the weld site 16 as prescribed by the weld schedule. The passage of the welding current causes the steel workpiece 20 to initially heat up more quickly than the aluminum alloy workpiece 22 since it has higher thermal and electrical conductivities than the aluminum alloy workpiece 22. The cover plate 10 does not heat up in the same way relative to the aluminum alloy workpiece 22 because it has lower thermal and electrical resistivities. Eventually, as before, the heat generated from the resistance to the flow of the electrical current across the faying interface 32 initiates the molten aluminum alloy weld pool 68 within the aluminum alloy workpiece 22, as shown in FIG. 12. The continued passage of the electrical current ultimately grows the molten aluminum alloy weld pool 68 to the desired size, which typically penetrates the aluminum alloy workpiece 22 to a distance that ranges from about 20% to about 100% of the thickness 220 of the workpiece 22.

The electrical current passed between the welding electrodes 48, 52 assumes the conical flow pattern 60 as described above. The inducement of the conical electrical current flow pattern 60 within the aluminum alloy workpiece 22 results in heat being concentrated within a smaller zone in the steel workpiece 20 as compared to the aluminum alloy workpiece 22. The weld schedule can even be set in this embodiment, if desired, to initiate and grow a molten steel weld pool 86 within the confines of the steel workpiece 20 in addition to initiating and growing the molten aluminum alloy weld pool 68 within the aluminum alloy workpiece 22 and at the faying interface 32 such that the molten aluminum alloy weld pool 68 wets the faying surface 24 of the steel workpiece 20. FIG. 12 illustrates the presence of both the molten aluminum alloy weld pool 68 and the molten steel weld pool 86. The heat generated by the electrical current, however, does not always have to be so concentrated within the steel workpiece 20 that the molten steel weld pool 86 is initiated and grown.

Upon cessation of the electrical current flow, the molten aluminum alloy weld pool 68 solidifies to form the weld joint 70 the bonds the steel and aluminum alloy workpieces 20, 22 together at the faying interface 32, as shown in FIG. 13. The molten steel weld pool 86, if formed, likewise solidifies at this time into a steel weld nugget 88 within the steel workpiece 20, although it preferably does not extend to either the faying surface 24 or the exterior surface 26 of that workpiece 20. The weld joint 70 includes the aluminum alloy weld nugget 72 and, typically, the one or more reaction layers 74 of Fe—Al intermetallic compounds as previously described. Here, as shown in FIG. 13, the aluminum alloy weld nugget 72 penetrates to a distance that preferably ranges from about 20% to about 100% of the thickness 220 of the aluminum alloy workpiece 22. The one or more reaction layers 74 of Fe—Al intermetallic compounds, if present, are usually 1 μm to 3 μm thick in at least the portion of the weld joint 70 underneath where the intruding feature 12 was present, although in some instances it may be greater than that since more heat is generated in the steel workpiece 20 than in the cover plate 10.

The use of the copper plate 10 in this embodiment is believed to improve the strength and integrity of the weld joint 70 by inducing the conical electrical current flow pattern 60 in the aluminum alloy workpiece 22. As already explained, the inducement of the conical electrical current flow pattern 60 concentrates heat within a smaller zone in the steel workpiece 20 at the weld site 16 as compared to the aluminum alloy workpiece 22, which changes the temperature distribution through the weld site 16 by creating three-dimensional radial temperature gradients within the plane of the steel workpiece 20 that are reflected in the plane of the aluminum alloy workpiece 22. These gradients help disseminate heat laterally through the workpieces 20, 22 such that the solidification front of the molten aluminum alloy weld pool 68 moves inward from the perimeter of the weld pool 68 as opposed to directionally towards the faying interface 32, as described above. Moreover, if the cover plate 10 is placed in direct contact with the aluminum alloy workpiece 22 and the intruding feature 12 is open at the aluminum alloy workpiece 22, as shown for example in FIGS. 4 and 6, the intruding feature 12 allows for the movement or stirring of the molten aluminum alloy weld pool during current flow that is believed to be beneficial as previously described.

Additionally, in instances where the molten steel weld pool 86 is initiated, the faying surface 24 of the steel workpiece 20 tends to distort away from the exterior surface 26. Such distortion can cause the steel workpiece 20 to thicken at the weld site 16 by as much as 50%. Increasing the thickness 200 of the steel workpiece 20 in this way helps maintain an elevated temperature at the center of the molten aluminum alloy weld pool 68—allowing it to cool and solidify last—which can further increase radial temperature gradients and drive weld defects towards the center of the weld joint 70. The swelling of the faying surface 24 of the steel workpiece 20 can also inhibit or disrupt formation of the one or more reaction layers 74 of Fe—Al intermetallic compounds that tend to form at the interface of the molten aluminum alloy weld pool 68 and the faying surface 24 of the steel workpiece 20. Still further, once the weld joint 70 is in service, the swelling of the faying surface 24 of the steel workpiece 20 can interfere with crack propagation around the weld joint 70 by deflecting cracks along a non-preferred path.

The embodiments described above and shown in FIGS. 1-13 are directed to instances in which the workpiece stack-up 14 includes one steel workpiece 20, which includes an exterior surface 26 that provides and delineates the first side 34 of the stack-up 14, and one aluminum alloy workpiece 22 that lies adjacent to the steel workpiece 20 and includes an exterior surface 30 that provides and delineates an opposed second side 36 of the stack-up 14. In other instances, however, a workpiece stack-up may include an additional steel workpiece or an additional aluminum alloy workpiece—in addition to the adjacent steel and aluminum alloy workpieces 20, 22—so long as an aluminum alloy workpiece provides and delineates one side of the workpiece stack-up 14 and a steel workpiece provides and delineates the opposed other side of the stack-up 14. When the cover plate 10 is used with three-workpiece stack-ups of this variety, it functions in generally the same manner and has the same general effect on a weld joint formed between the adjacent steel and aluminum alloy workpieces as previously described.

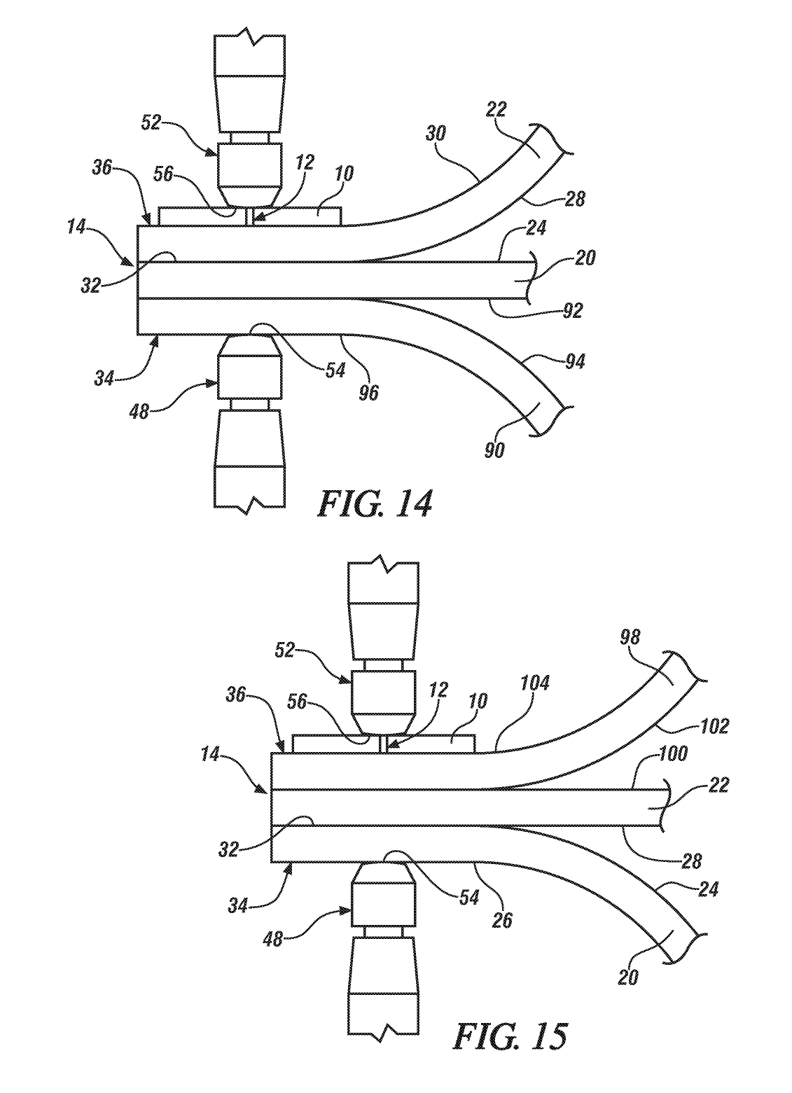

As shown in FIG. 14, for example, the workpiece stack-up 14 may include the adjacent steel and aluminum alloy workpieces 20, 22 described above in addition to another steel workpiece 90. Here, as shown, the additional steel workpiece 90 overlaps the adjacent steel and aluminum alloy workpieces 20, 22 and is positioned next to the steel workpiece 20. When the additional steel workpiece 90 is so positioned, the exterior surface 30 of the aluminum alloy workpiece 22 provides and delineates the second side 36 of the workpiece stack-up 14, as before, while the steel workpiece 20 that lies adjacent to the aluminum alloy workpiece 22 now includes a pair of opposed faying surfaces 24, 92. The faying surface 24 of the steel workpiece 20 that confronts and contacts the adjacent faying surface 28 of the aluminum alloy workpiece 22 establishes the faying interface 32 between the two workpieces 20, 22. The faying surface 92 of the steel workpiece 20 that faces in the opposite direction confronts and makes overlapping contact with a faying surface 94 of the additional steel workpiece 92. As such, in this particular arrangement of lapped workpieces 20, 22, 92, an exterior surface 96 of the additional steel workpiece 92 now provides and delineates the first side 34 of the workpiece stack-up 14.

In another example, as shown in FIG. 15, the workpiece stack-up 14 may include the adjacent steel and aluminum alloy workpieces 20, 22 described above in addition to another aluminum alloy workpiece 98. Here, as shown, the additional aluminum alloy workpiece 98 overlaps the adjacent steel and aluminum alloy workpieces 20, 22 and is positioned next to the aluminum alloy workpiece 22. When the additional aluminum alloy workpiece 98 is so positioned, the exterior surface 26 of the steel workpiece 20 provides and delineates the first side 34 of the workpiece stack-up 14, as before, while the aluminum alloy workpiece 22 that lies adjacent to the steel workpiece 20 now includes a pair of opposed faying surfaces 28, 100. The faying surface 28 of the aluminum alloy workpiece 22 that confronts and contacts the adjacent faying surface 24 of the steel workpiece 20 establishes the faying interface 32 between the two workpieces 20, 22. The faying surface 100 of the aluminum alloy workpiece 22 that faces in the opposite direction confronts and makes overlapping contact with a faying surface 102 of the additional aluminum alloy workpiece 98. As such, in this particular arrangement of lapped workpieces 20, 22, 98, an exterior surface 104 of the additional aluminum alloy workpiece 98 now provides and delineates the second side 36 of the workpiece stack-up 14.

The cover plate 10 can be used to help spot weld the workpiece stack-ups 14 depicted in each of FIGS. 14 and 15 and to enhance the strength of a weld joint formed between the adjacent steel and aluminum alloy workpieces 20, 22 contained within the stack-ups 14 in the same general way as before. Specifically, the cover plate 10 is located adjacent to, and preferably lies in direct contact against, the second side 36 of the workpiece stack-up 14, which may be the exterior surface 30 of the aluminum alloy workpiece 22 that lies adjacent to the steel workpiece 20 (FIG. 14) or the exterior surface 104 of the additional aluminum alloy workpiece 98 (FIG. 15). The cover plate 10 is located so that the intruding feature 12 is present at the weld site 16. The cover plate 10, moreover, may have thermal and electrical resistivities that are greater than or less than the thermal and electrical resistivities of the aluminum alloy workpiece 22 that lies adjacent to the steel workpiece 20.

After the cover plate 10 has been properly located, the weld face 54 of the first welding electrode 48 is pressed against the first side of the workpiece stack-up 14, which may be the exterior surface 26 of the steel workpiece 20 that lies adjacent to the aluminum alloy workpiece 22 (FIG. 15) or the exterior surface 96 of the additional steel workpiece 92 (FIG. 14), and the weld face 56 of the second welding electrode 52 is pressed against the exterior surface 40 of the cover plate 10 over the intruding feature 12. An electrical current is then exchanged between the axially and facially aligned weld faces 54, 56 of the welding electrodes 48, 52 to form a weld joint that bonds the adjacent steel and aluminum alloy workpieces 20, 22 together as described above. The cover plate 10, as before, induces the conical electrical current flow pattern within the aluminum alloy workpiece 22 that lies adjacent to the steel workpiece 20 to help the molten aluminum alloy weld pool created therein by the electrical current solidify into the weld joint in a more desirable way. The cover plate 10 may also be used to generate and retain heat at the second side 36 of the workpiece stack-up 14.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of spot welding a workpiece stack-up that includes a steel workpiece and an adjacent aluminum alloy workpiece, the method comprising:
providing a workpiece stack-up that includes a steel workpiece and an aluminum alloy workpiece that overlaps and lies adjacent to the steel workpiece to establish a faying interface at a weld site, the workpiece stack-up having a first side and a second side, the first side of the workpiece stack-up being proximate the steel workpiece and the second side of the workpiece stack-up being proximate the aluminum alloy workpiece;
locating a cover plate adjacent to the second side of the workpiece stack-up, the cover plate having an interior surface that confronts the second side of the workpiece stack-up and exterior surface that faces in an opposite direction from the interior surface, the cover plate further comprising an intruding feature aligned with the weld site;
pressing a first weld face of a first welding electrode against the first side of the workpiece stack-up and pressing a second weld face of a second welding electrode against the exterior surface of the cover plate over the intruding feature, the first and second weld faces of the first and second welding electrodes being facially aligned at the weld site; and
passing an electrical current between the first and second welding electrodes and through the workpiece stack-up at the weld site to create a molten aluminum alloy weld pool within the aluminum alloy workpiece, the molten aluminum alloy weld pool wetting an adjacent faying surface of the steel workpiece, and wherein the molten aluminum alloy weld pool solidifies into a weld joint that bonds the adjacent steel and aluminum alloy workpieces together at their faying interface upon ceasing passage of the electrical current through the workpiece stack-up.

2. The method set forth in claim 1, wherein the steel workpiece has an exterior surface that provides and delineates the first side of the workpiece stack-up and the aluminum alloy workpiece has an exterior surface that provides and delineates the second side of the workpiece stack-up.

3. The method set forth in claim 1, wherein the workpiece stack-up further comprises an additional steel workpiece that overlaps and is positioned next to the steel workpiece that lies adjacent to the aluminum alloy workpiece, and wherein the additional steel workpiece has an exterior surface that provides and delineates the first side of the workpiece stack-up and the aluminum alloy workpiece has an exterior surface that provides and delineates the second side of the workpiece stack-up.

4. The method set forth in claim 1, wherein the workpiece stack-up further comprises an additional aluminum alloy workpiece that overlaps and is positioned next to the aluminum alloy workpiece that lies adjacent to the steel workpiece, and wherein the steel workpiece has an exterior surface that provides and delineates the first side of the workpiece stack-up and the additional aluminum alloy workpiece has an exterior surface that provides and delineates the second side of the workpiece stack-up.

5. The method set forth in claim 1, wherein the cover plate is constructed from a material that has a thermal resistivity and an electrical resistivity that are greater than a thermal resistivity and an electrical resistivity, respectively, of the aluminum alloy workpiece that lies adjacent to the steel workpiece.

6. The method set forth in claim 1, wherein the material of the cover plate has a thermal conductivity that is at least twice as great as the thermal conductivity of commercially pure annealed copper, and further wherein the material of the cover plate has an electrical conductivity that is at least twice as great as 100% IACS.

7. The method set forth in claim 6, wherein the cover plate is constructed from molybdenum, stainless steel, or a tungsten-copper alloy.

8. The method set forth in claim 1, wherein the cover plate is constructed from a material that has a thermal resistivity and an electrical resistivity that are less than a thermal resistivity and an electrical resistivity, respectively, of the aluminum alloy workpiece that lies adjacent to the steel workpiece.

9. The method set forth in claim 8, wherein the cover plate is constructed from a copper alloy.

10. The method set forth in claim 1, wherein the intruding feature is a through hole that extends entirely through the cover plate from the interior surface of the cover plate to the exterior surface of the cover plate.

11. The method set forth in claim 1, wherein the intruding feature is a depression that partially traverses a thickness of the cover plate, the depression extending from the exterior surface of the cover plate but not reaching the interior surface of the cover plate.

12. The method set forth in claim 1, wherein the intruding feature is a depression that partially traverses a thickness of the cover plate, the depression extending from the interior surface of the cover plate but not reaching the exterior surface of the cover plate.

13. The method set forth in claim 1, wherein the weld joint comprises an aluminum alloy weld nugget and one or more reaction layers of intermetallic compounds between the aluminum alloy weld nugget and the adjacent steel workpiece.

14. The method set forth in claim 1, wherein the step of passing electrical current between the first and second welding electrodes further comprises:
creating a molten steel weld pool within the steel workpiece that lies adjacent to the aluminum alloy workpiece, the molten steel weld pool causing a thickness of the steel workpiece to increase towards the adjacent aluminum alloy workpiece by up to 50% at the weld site, and wherein the molten steel weld pool solidifies into a steel weld nugget upon ceasing passage of the electrical current through the workpiece stack-up.

15. A method of spot welding a workpiece stack-up that includes a steel workpiece and an adjacent aluminum alloy workpiece, the method comprising:
providing a workpiece stack-up that includes a steel workpiece and an aluminum alloy workpiece that overlaps and lies adjacent to the steel workpiece to establish a faying interface between the steel and adjacent aluminum alloy workpieces at a weld site, the workpiece stack-up having a first side and a second side, the first side of the workpiece stack-up being proximate the steel workpiece and the second side of the workpiece stack-up being proximate the aluminum alloy workpiece;
locating a cover plate adjacent to the second side of the workpiece stack-up, the cover plate having an interior surface that confronts the second side of the workpiece stack-up and exterior surface that faces in an opposite direction from the interior surface, the cover plate further comprising an intruding feature aligned with the weld site;
pressing a first weld face of a first welding electrode against the first side of the workpiece stack-up and pressing a second weld face of a second welding electrode against the exterior surface of the cover plate over the intruding feature, the first and second weld faces of the first and second welding electrodes being facially aligned at the weld site;
creating a molten aluminum alloy weld pool within the aluminum alloy workpiece by passing an electrical current between the first and second welding electrodes and through the workpiece stack-up at the weld site, the electrical current assuming a conical flow pattern within the aluminum alloy workpiece that expands radially from the faying interface of the steel and aluminum alloy workpieces towards the second welding electrode thereby causing a current density of the electrical current to decrease directionally within the aluminum alloy workpiece from the faying interface towards the second welding electrode;
ceasing passage of the electrical current between the first and second welding electrodes to allow the molten aluminum alloy weld pool to solidify into a weld joint that bonds the adjacent steel and aluminum alloy workpieces together at their faying interface.

16. The method set forth in claim 15, wherein the steel workpiece has an exterior surface that provides and delineates the first side of the workpiece stack-up and the aluminum alloy workpiece has an exterior surface that provides and delineates the second side of the workpiece stack-up.

17. The method set forth in claim 15, wherein the cover plate is constructed from molybdenum, stainless steel, or a tungsten-copper alloy.

18. The method set forth in claim 15, wherein the cover plate is constructed from a copper alloy.

19. The method set forth in claim 15, further comprising:
creating a molten steel weld pool within the steel workpiece that lies adjacent to the aluminum alloy workpiece with the electrical current that is passed between the first and second welding electrodes, the molten steel weld pool being created at the same time as the molten aluminum alloy weld pool.

20. The method set forth in claim 19, wherein the molten steel weld pool causes a thickness of the steel workpiece to increase towards the adjacent aluminum alloy workpiece by up to 50% at the weld site, and wherein the molten steel weld pool solidifies into a steel weld nugget upon ceasing passage of the electrical current through the workpiece stack-up.
